(19) United States
(12) Patent Application Publication
(10) Pub. No.: US 2026/0044143 A1
(43) Pub. Date: Feb. 12, 2026

(54) MONITORING FOR A MIDSTREAM FACILITY

(71) Applicant: Schlumberger Technology Corporation, Sugar Land, TX (US)

(72) Inventor: Swapnil Dubey, Pune (IN)

(21) Appl. No.: 18/894,145

(22) Filed: Sep. 24, 2024

(30) Foreign Application Priority Data
Aug. 6, 2024 (IN) 202411059426

(51) Int. Cl. G05B 23/02

(52) U.S. Cl. CPC G05B 23/0286; G05B 23/0275

(57) ABSTRACT

A method for solving a problem with equipment in a midstream oil and gas facility includes receiving first input data related to first equipment. The first input data includes actions to perform to try to solve a problem with the first equipment. The method also includes receiving second input data related to second equipment. The method also includes modifying an order of the actions based upon the second input data to produce a modified order. The method also includes receiving third input data related to third equipment. The method also includes determining that the third equipment has the problem based upon the third input data. The method also includes selecting one of the actions to perform in response to determining that the third equipment has the problem. The selected action is based upon the modified order of the actions.

### BACKGROUND

Oil and gas facilities include various equipment, such as compressors, dehydrators, desalters, etc. When crude oil passes through this equipment in a mid-stream oil and gas facility, the equipment makes the non-usable crude oil usable. The equipment may include (e.g., be mounted with) sensors, which measure and emit data using software applications. These software applications have the capability to know when an unwanted situation (e.g., failure) occurs. When a field engineer logs into the applications, the applications can suggest guided action items to be completed to ensure the smooth running of the facilities.

The guided actions may be from the manual of an original equipment manufacturer (OEM). However, sometimes, field engineers may try other actions, which may work better or worse than those in the manual. Therefore, what is needed is an improved system and method that continuously updates the guided actions for each unwanted situation.

### SUMMARY

A method for solving a problem with equipment in a midstream oil and gas facility includes receiving first input data related to first equipment. The first input data includes actions to perform to try to solve a problem with the first equipment. The method also includes receiving second input data related to second equipment. The method also includes modifying an order of the actions based upon the second input data to produce a modified order. The method also includes receiving third input data related to third equipment. The method also includes determining that the third equipment has the problem based upon the third input data. The method also includes selecting one of the actions to perform in response to determining that the third equipment has the problem. The selected action is based upon the modified order of the actions.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving first input data related to first equipment. The first input data is received from an original equipment manufacturer (OEM) of the first equipment. The first input data includes parameters related to the first equipment at a time that the first equipment has a problem. The first input data also includes actions to perform to try to solve the problem. Each of the parameters has a corresponding subset of the actions that are presented in an order. The operations also include receiving second input data related to second equipment. The second input data is received from a plurality of users of the second equipment. The second input data includes the parameters related to the second equipment at a time that the second equipment has the problem. The second input data also includes the actions performed by the users that solve the problem, as well as the actions performed by the users that did not solve the problem. The actions performed by the users that solve the problem differ from the actions in the first input data. The operations also include modifying the order of the actions based upon the second input data to produce a modified order. The order is modified based upon the actions performed by the users that solve the problem, as well as the actions performed by the users that did not solve the problem. The operations also include receiving third input data related to third equipment. The third input data is measured by one or more sensors on the third equipment. The third input data includes an indication that the third equipment has the problem. The third input data also includes the parameters related to the third equipment at a time that the third equipment has the problem. The operations also include determining, based upon the third input data, that one or more of the parameters related to the third equipment breached a threshold at the time that the third equipment has the problem. The operations also include selecting one of the actions to perform in response to the one or more parameters related to the third equipment breaching the threshold. The selected action is based upon the one or more of the parameters related to the third equipment that breached the threshold and the modified order of the actions.

A non-transitory computer-readable medium is also disclosed. The medium stores instructions that, when executed by one or more processors of a computing system, cause the computing system to perform operations. The operations include receiving first input data related to first equipment. The first input data is received from an original equipment manufacturer (OEM) of the first equipment. The first input data includes parameters related to the first equipment at a time that the first equipment has a problem. The first input data also includes actions to perform to try to solve the problem. Each of the parameters has a corresponding subset of the actions that are presented in an order. The first equipment includes a first compressor. The parameters include a vibration, a throw temperature, an impact, a knocking force or volume, a pressure, a flow rate or amount of lubricant, or a combination thereof. The actions include replacing a valve, replacing a switch, tightening a loose component, replacing a broken component, changing a setting, or a combination thereof. The operations also include receiving second input data related to second equipment. The second input data is received from a plurality of users of the second equipment. The second input data includes the parameters related to the second equipment at a time that the second equipment has the problem. The second input data also includes the actions performed by the users that solve the problem, as well as the actions performed by the users that did not solve the problem. The actions performed by the users that solve the problem differ from the actions in the first input data. The second equipment is a second compressor that is a same make and model as the first compressor. The operations also include modifying the order of the actions based upon the second input data to produce a modified order. The order is modified based upon the actions performed by the users that solve the problem, as well as the actions performed by the users that did not solve the problem. The order is also modified based upon a number of times that each action solved the problem. The operations also include receiving third input data related to third equipment. The third input data is measured by one or more sensors on the third equipment. The third input data includes an indication that the third equipment has the problem. The third input data also includes the parameters related to the third equipment at a time that the third equipment has the problem. The third equipment is a third compressor that is a same make and model as the first compressor and the second compressor. The third equipment causes a gas to move within a line in a facility. The gas is a natural gas. The facility is a midstream oil and gas facility. The operations also include generating an alert in response to determining that the third equipment has the problem. The operations also include determining, based upon the third input data, that one or more of the parameters related to the third equipment breached a threshold at the time that the third equipment has the problem. The operations also include selecting one of the actions to perform in response to the one or more parameters related to the third equipment breaching the threshold. The selected action is based upon the second input data and the third input data. The selected action is further based upon the one or more of the parameters related to the third equipment that breached the threshold and the modified order of the actions. The operations also include performing the selected action. The operations also include determining whether the selected action solves the problem for the third equipment. The operations also include updating the modified order of the actions based upon the determination whether the selected action solves the problem for the third equipment.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flow diagram showing a SME receiving an alert, taking action, and recording feedback, according to an embodiment.

FIG. 3 illustrates a schematic view of equipment (e.g., a compressor), according to an embodiment.

FIG. 4 illustrates an enlarged cross-sectional view of a portion (e.g., the cylinder) of the compressor, according to an embodiment.

FIG. 5 illustrates a flowchart of a method for solving a problem with the equipment, according to an embodiment.

FIG. 6 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining”or “in response to detecting,”depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

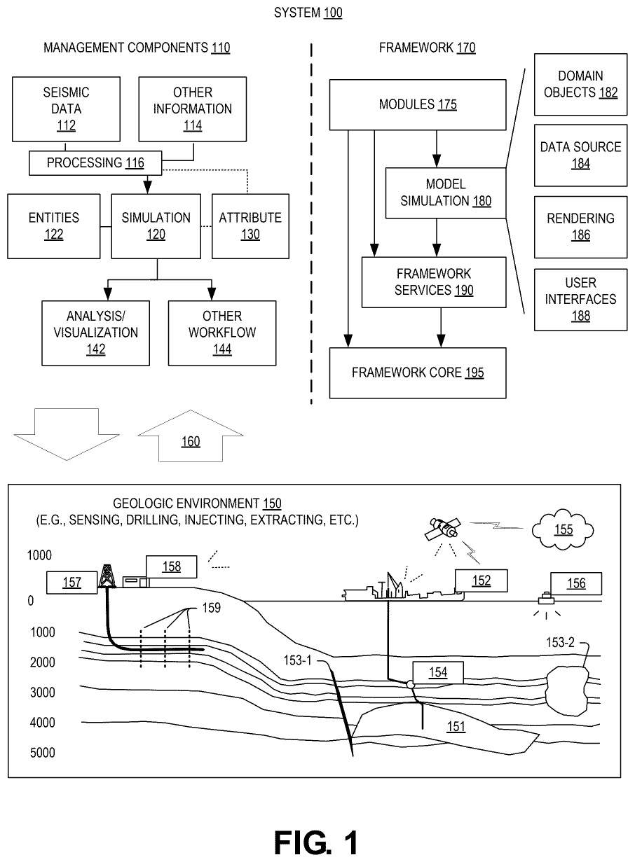

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Smart Monitoring for Midstream Facility

In production midstream facility monitoring applications, a knowledge base refers to a set of actions that can be taken to resolve an issue that has occurred in a facility. This knowledge base can start with basic recommendations (e.g., static) pre-fed by the original equipment manufacturer (OEM) of the equipment. The knowledge base can also grow over time, with a subject matter expert (SME) feeding the details of different actions into the system. The different actions may be ones that are not suggested by the OEM. Some of these different actions may solve the issue better than the actions suggested by the OEM, and some may work worse (e.g., not solve the issue). In some embodiments, a solution that solves the problem in one situation may be used in similar other situations. This may be captured and suggested to the field engineer for faster action.

This setup may lead to one or more actions, which may be presented as a prioritized list of similar situations for the same oil facility or a different oil facility. Equipment sold to multiple clients by the same OEM (e.g., equipment with similar model numbers), can leverage the prioritized knowledge base for taking more assured and accurate actions. This may result in an efficient system that reports an issue and suggests actions to take to resolve the issue.

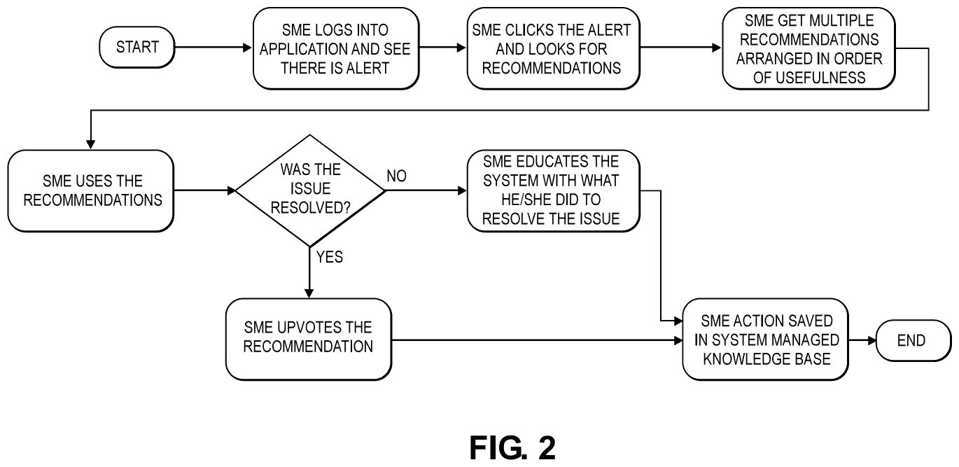

FIG. 2 illustrates a flow diagram showing a SME receiving an alert, taking action, and recording feedback, according to an embodiment. The algorithm to determine the priority of one suggested action over another may depend on the number of times an action was voted upon by an SME. This may ensure that the most relevant actions are presented at the top of the list. If this is implemented, this may ensure that production midstream applications identify the problem and suggest actions to SMEs, giving them more assurance about the actions that they perform. The more this system is used (e.g., the more the SME feeds the real-time actions in the system), the better the quality of recommendations may be.

Midstream applications (e.g., ProcessOps) may create events and provide a way to hold discussions with the OEM team. Sometimes, an issue occurs across two different facilities. When this occurs, the SMEs belonging to different facilities may schedule a call or meet to discuss the issue. The method described herein may streamline the process and resolve the issue more quickly. The method may store the real-world actions taken by SMEs to resolve issues. It may also continue updating a score against (i.e., corresponding to) an action, which over time may become an effective knowledge base, making on-field decision-making more effective.

The workflow may not disrupt an established workflow. It is presented as an option to SMEs if they want to see a system-generated action list. Hence, it may be easily configurable to existing applications such as ProcessOps. The same workflow may be used in future production midstream applications such as the Artemis suite of applications.

This workflow may not be tied to just mid-stream facilities. For example, a similar workflow may be leveraged for any application that deals with equipment and involves SMEs taking actions to optimize work. This workflow may reduce time and provide more confidence to SMEs before acting.

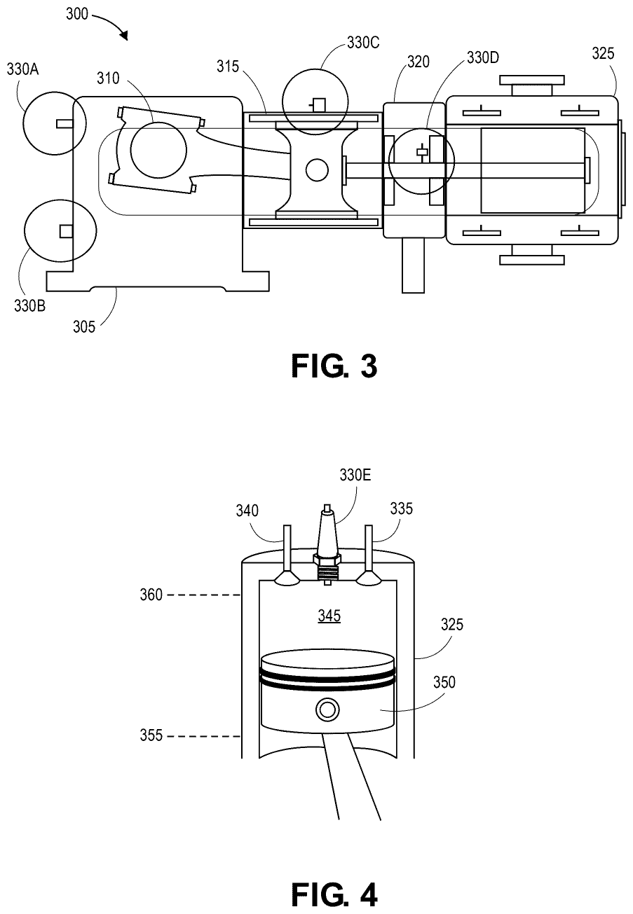

FIG. 3 illustrates a schematic view of equipment (e.g., a compressor) 300, according to an embodiment. The equipment 300 may be used in an oil and gas facility, such as a midstream oil and gas facility. Although a compressor 300 is shown, the equipment may also or instead include a generator, a dehydrator, a desalter, etc. The compressor 300 may be or include a reciprocating compressor that is configured to move gas (e.g., natural gas) through a pipeline.

The compressor 300 may include a frame 305. A crankshaft 310 may be positioned within the frame 305. The crankshaft 310 may be positioned adjacent to and/or extend through a crosshead 315. The crosshead 315 may be positioned adjacent to a distance piece 320. The distance piece 320 may be positioned adjacent to a cylinder 325.

The compressor 300 may also include one or more sensors (four are shown: 330A-330D). More particularly, the compressor 300 may also include a vibration sensor 330A that is coupled to the frame 305 and configured to measure vibration. The compressor 300 may also include a temperature sensor 330B that is coupled to the frame 305 (e.g., proximate to the crankshaft 310) and configured to measure temperature (e.g., throw temperature). The compressor 300 may also include an impact sensor 330C that is coupled to the frame 305 (e.g., the crosshead 315) and configured to measure impact. The compressor 300 may also include a rod drop sensor 330D that is positioned within the frame 305 (e.g., the distance piece 320). If one or more mechanical parts are loosened, they may create noise (referred to as knocking), which may be detected by the rod drop sensor 330D. As described below, these loosened parts may be tightened or replaced to remove the knocking.

FIG. 4 illustrates an enlarged cross-sectional view of a portion (e.g., the cylinder 325) of the compressor 300, according to an embodiment. The cylinder 325 may include a first (e.g., intake) valve 335 and a second (e.g., outlet) valve 340. Both valves 335, 340 may provide fluid communication between a bore 345 of the cylinder 325 and an exterior of the cylinder 325. The cylinder 325 may also include a piston 350 that is configured to stroke (e.g., vertically) between a first (e.g., bottom dead center) position 355 and a second (e.g., top dead center) position 360.

The cylinder 325 may also include a pressure sensor 330E that is positioned at least partially though the (e.g., top) wall of the cylinder 325. More particularly, the pressure sensor 330E may be positioned between the intake valve 335 and the outlet valve 340. The pressure sensor 330E may be configured to measure the pressure within the bore 345.

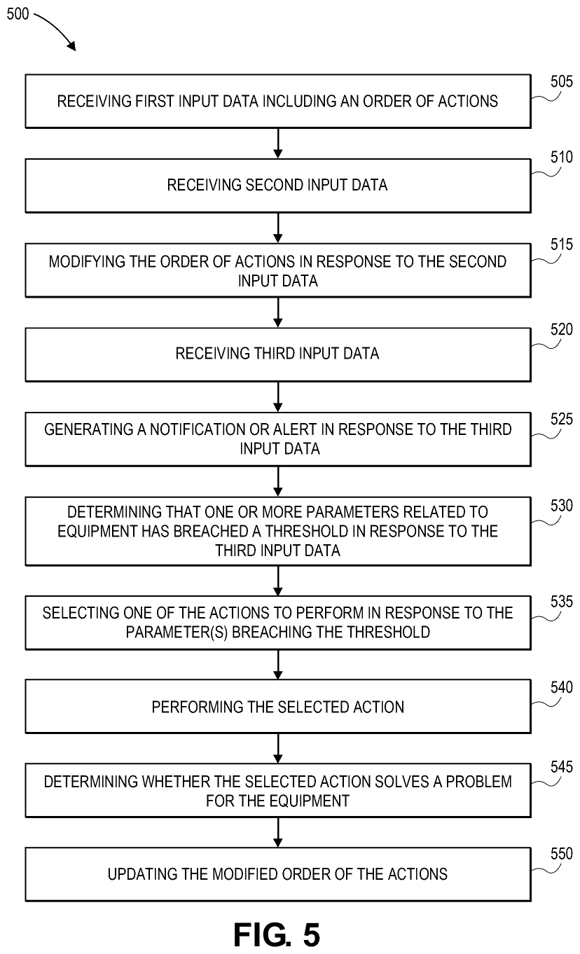

FIG. 5 illustrates a flowchart of a method 500 for solving a problem with equipment 300, according to an embodiment. An illustrative order of the method 500 is provided below; however, one or more portions of the method 500 may be performed in a different order, simultaneously, repeated, or omitted. At least a portion of the method 500 may be performed by a computing system.

The method 500 may include receiving first input data, as at 505. The first input data may be related to first equipment (e.g., a first compressor). The first input data may be received from an original equipment manufacturer (OEM) of the first equipment. The first input data may include one or more parameters related to the first equipment at a time that the first equipment has a problem. Illustrative parameters may include vibration, (e.g., throw) temperature, impact, knocking force or volume, pressure, a flow rate or amount of lubricant, or a combination thereof. Thus, illustrative problems may include the vibration exceeding a predetermined vibration threshold, the (e.g., throw) temperature exceeding a predetermined temperature threshold, the impact exceeding a predetermined impact threshold, the knocking force or volume exceeding a predetermined knocking threshold, the pressure exceeding a predetermined pressure threshold, the flow rate or amount of lubricant exceeding a predetermined flow threshold, the first compressor failing (i.e., ceasing to work), or a combination thereof. The first input data may also include actions to perform to try to solve the problem. Illustrative actions may include replacing a valve, replacing a switch, tightening a loose component, replacing a broken component, changing a setting, or a combination thereof. Each of the problems and/or parameters may have a corresponding subset of the actions that may be presented in an order.

The method 500 may also include receiving second input data, as at 510. The second input data may be related to second equipment. The second input data may be received from a plurality of users of the second equipment. The second input data may include the parameters related to the second equipment at a time that the second equipment has the problem. The second input data may also include the actions performed by the users that solve the problem. The second input data may also include the actions performed by the users that did not solve the problem. In one embodiment, the actions performed by the users that solve the problem may differ from the actions in the first input data. The second equipment may be (e.g., a second compressor that is) a same make and/or model as the first equipment.

The method 500 may also include modifying the order of the actions, as at 515. The order may be modified based upon the second input data to produce a modified order. The order may be modified based upon the actions performed by the users that solve the problem, and/or the actions performed by the users that did not solve the problem. The order may also or instead be modified based upon a number of times that each action solved the problem.

The method 500 may also include receiving third input data, as at 520. The third input data may be related to third equipment (e.g., the compressor) 300. The third input data may be measured by one or more sensors 330A-330E on the third equipment 300. The third input data may include an indication that the third equipment 300 has the problem. The third input data may also include the parameters related to the third equipment 300 at a time that the third equipment has the problem. The third equipment 300 may be a same make and/or model as the first equipment and/or the second equipment. The third equipment may cause a gas to move within a line in a facility. The gas may be or include natural gas. The facility may be or include a midstream oil and gas facility.

The method 500 may also include generating a notification or alert in response to determining that the third equipment 300 has the problem, as at 525.

The method 500 may also include determining that one or more of the parameters related to the third equipment breached a threshold at the time that the third equipment has the problem, as at 530. The determination may be in response to or based upon the third input data. The threshold may be an upper and/or lower threshold. The threshold may be any of the ones listed above.

The method 500 may also include selecting one of the actions to perform, as at 535. The selection may be in response to determining that the third equipment 300 has the problem. The selected action is based upon the first input data, the second input data, and/or the third input data. The selected action may also or instead be based upon the one or more of the parameters related to the third equipment that breached the threshold. The selected action may also or instead be based upon the modified order of the actions.

The method 500 may also include performing the selected action, as at 540. The selected action may be or include generating and/or transmitting a signal (e.g., using a computing system) that instructs or causes a physical action to occur at/in the facility (e.g., in the third equipment 300). The selected action may also or instead include physically performing the selected action.

The method 500 may also include determining whether the selected action solves the problem for the third equipment 300, as at 545.

The method 500 may also include updating the modified order of the actions, as at 550. The modified order may be updated based upon the determination whether the selected action solves the problem for the third equipment 300.

### Exemplary Computing System

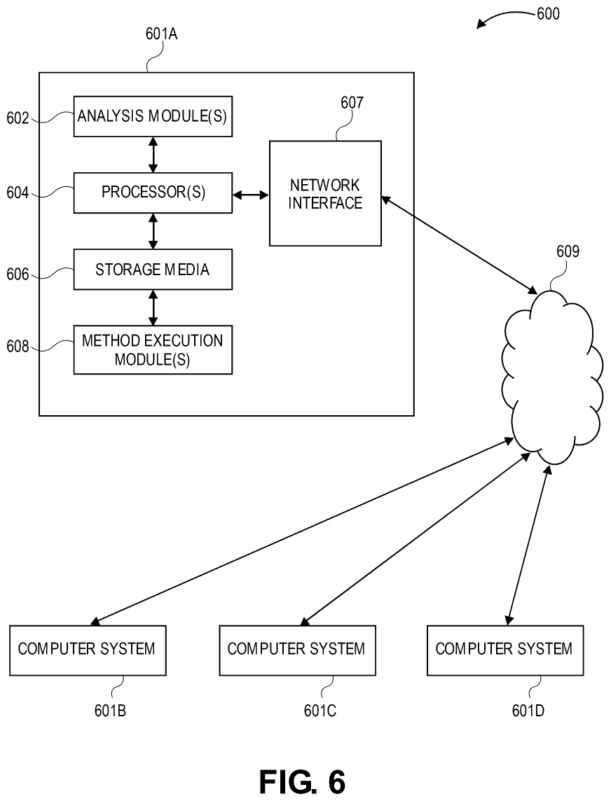

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more method execution module(s) 608. In the example of computing system 600, computer system 601A includes the method execution module 608. In some embodiments, a single method execution module may be used to perform some aspects of one or more embodiments of the methods disclosed herein. In other embodiments, a plurality of method execution modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for solving a problem with equipment in a midstream oil and gas facility, the method comprising:
receiving first input data related to first equipment, wherein the first input data comprises actions to perform to try to solve a problem with the first equipment;
receiving second input data related to second equipment;
modifying an order of the actions based upon the second input data to produce a modified order;
receiving third input data related to third equipment;
determining that the third equipment has the problem based upon the third input data; and
selecting one of the actions to perform in response to determining that the third equipment has the problem, wherein the selected action is based upon the modified order of the actions.

2. The method of claim 1, wherein the first input data is received from an original equipment manufacturer (OEM) of the first equipment, and wherein the second input data is received from a plurality of users of the second equipment.

3. The method of claim 1, wherein the first input data comprises parameters related to the first equipment at a time that the first equipment has a problem, wherein the second input data comprises the parameters related to the second equipment at a time that the second equipment has the problem, and wherein the third input data comprises the parameters related to the third equipment at a time that the third equipment has the problem.

4. The method of claim 3, wherein each of the parameters has a corresponding subset of the actions that are presented in different orders.

5. The method of claim 3, wherein determining that the third equipment has the problem comprises determining that one or more of the parameters related to the third equipment breached a threshold at the time that the third equipment has the problem.

6. The method of claim 5, wherein the selected action is also based upon one or more of the parameters related to the third equipment that breached the threshold.

7. The method of claim 1, wherein the second input data also comprises the actions performed by the users that solve the problem, as well as the actions performed by the users that did not solve the problem.

8. The method of claim 7, wherein the order is modified based upon the actions performed by the users that solve the problem, as well as the actions performed by the users that did not solve the problem.

9. The method of claim 1, wherein the third input data is measured by one or more sensors on the third equipment, and wherein the third input data comprises an indication that the third equipment has the problem.

10. The method of claim 1, further comprising:
performing the selected action;
determining whether the selected action solves the problem for the third equipment; and
updating the modified order of the actions based upon the determination whether the selected action solves the problem for the third equipment.

11. A computing system, comprising:
one or more processors; and
a memory system comprising one or more non-transitory computer-readable media storing instructions that, when executed by at least one of the one or more processors, cause the computing system to perform operations, the operations comprising:
receiving first input data related to first equipment, wherein the first input data is received from an original equipment manufacturer (OEM) of the first equipment, wherein the first input data comprises parameters related to the first equipment at a time that the first equipment has a problem, wherein the first input data also comprises actions to perform to try to solve the problem, and wherein each of the parameters has a corresponding subset of the actions that are presented in an order;
receiving second input data related to second equipment, wherein the second input data is received from a plurality of users of the second equipment, wherein the second input data comprises the parameters related to the second equipment at a time that the second equipment has the problem, wherein the second input data also comprises the actions performed by the users that solve the problem, as well as the actions performed by the users that did not solve the problem, and wherein the actions performed by the users that solve the problem differ from the actions in the first input data;
modifying the order of the actions based upon the second input data to produce a modified order, wherein the order is modified based upon the actions performed by the users that solve the problem, as well as the actions performed by the users that did not solve the problem;
receiving third input data related to third equipment, wherein the third input data is measured by one or more sensors on the third equipment, wherein the third input data comprises an indication that the third equipment has the problem, and wherein the third input data also comprises the parameters related to the third equipment at a time that the third equipment has the problem;
determining, based upon the third input data, that one or more of the parameters related to the third equipment breached a threshold at the time that the third equipment has the problem; and
selecting one of the actions to perform in response to the one or more parameters related to the third equipment breaching the threshold, wherein the selected action is based upon the one or more of the parameters related to the third equipment that breached the threshold and the modified order of the actions.

12. The computing system of claim 11, wherein the first equipment comprises a first compressor, wherein the parameters comprise a vibration, a throw temperature, an impact, a knocking force or volume, a pressure, a flow rate or amount of lubricant, or a combination thereof, and wherein the actions comprise replacing a valve, replacing a switch, tightening a loose component, replacing a broken component, changing a setting, or a combination thereof.

13. The computing system of claim 11, wherein the first equipment, the second equipment, and the third equipment are a same make and/or model.

14. The computing system of claim 11, wherein the third equipment causes a gas to move within a line in a facility, wherein the gas comprises natural gas, and wherein the facility comprises a midstream oil and gas facility.

15. The computing system of claim 11, wherein the operations further comprise:
performing the selected action;
determining whether the selected action solves the problem for the third equipment; and
updating the modified order of the actions based upon the determination whether the selected action solves the problem for the third equipment.

16. A non-transitory computer-readable medium storing instructions that, when executed by one or more processors of a computing system, cause the computing system to perform operations, the operations comprising:
receiving first input data related to first equipment, wherein the first input data is received from an original equipment manufacturer (OEM) of the first equipment, wherein the first input data comprises parameters related to the first equipment at a time that the first equipment has a problem, wherein the first input data also comprises actions to perform to try to solve the problem, wherein each of the parameters has a corresponding subset of the actions that are presented in an order, wherein the first equipment comprises a first compressor, wherein the parameters comprise a vibration, a throw temperature, an impact, a knocking force or volume, a pressure, a flow rate or amount of lubricant, or a combination thereof, and wherein the actions comprise replacing a valve, replacing a switch, tightening a loose component, replacing a broken component, changing a setting, or a combination thereof;
receiving second input data related to second equipment, wherein the second input data is received from a plurality of users of the second equipment, wherein the second input data comprises the parameters related to the second equipment at a time that the second equipment has the problem, wherein the second input data also comprises the actions performed by the users that solve the problem, as well as the actions performed by the users that did not solve the problem, wherein the actions performed by the users that solve the problem differ from the actions in the first input data, and wherein the second equipment is a second compressor that is a same make and model as the first compressor;
modifying the order of the actions based upon the second input data to produce a modified order, wherein the order is modified based upon the actions performed by the users that solve the problem, as well as the actions performed by the users that did not solve the problem, and wherein the order is also modified based upon a number of times that each action solved the problem;
receiving third input data related to third equipment, wherein the third input data is measured by one or more sensors on the third equipment, wherein the third input data comprises an indication that the third equipment has the problem, wherein the third input data also comprises the parameters related to the third equipment at a time that the third equipment has the problem, wherein the third equipment is a third compressor that is a same make and model as the first compressor and the second compressor, wherein the third equipment causes a gas to move within a line in a facility, wherein the gas comprises natural gas, and wherein the facility comprises a midstream oil and gas facility;
generating an alert in response to determining that the third equipment has the problem;
determining, based upon the third input data, that one or more of the parameters related to the third equipment breached a threshold at the time that the third equipment has the problem;
selecting one of the actions to perform in response to the one or more parameters related to the third equipment breaching the threshold, wherein the selected action is based upon the second input data and the third input data, wherein the selected action is further based upon the one or more of the parameters related to the third equipment that breached the threshold and the modified order of the actions;
performing the selected action;
determining whether the selected action solves the problem for the third equipment; and
updating the modified order of the actions based upon the determination whether the selected action solves the problem for the third equipment.

17. The non-transitory computer-readable medium of claim 16, wherein the one or more sensors comprise a vibration sensor and a temperature sensor that are coupled to a frame of the third compressor, wherein the vibration sensor is positioned above the temperature sensor, wherein the vibration sensor measures the vibration, and wherein the temperature sensor measures the throw temperature.

18. The non-transitory computer-readable medium of claim 16, wherein the one or more sensors comprise an impact sensor that is coupled to a crosshead of the third compressor, and wherein the impact sensor is configured to measure the impact.

19. The non-transitory computer-readable medium of claim 16, wherein the one or more sensors comprise a rod drop sensor that is coupled to a distance piece of the third compressor, wherein the distance piece is positioned between a crosshead of the third compressor and a cylinder of the third compressor, and wherein the rod drop sensor is configured to measure the knocking force or volume.

20. The non-transitory computer-readable medium of claim 16, wherein the one or more sensors comprise a pressure sensor that is coupled to a cylinder of the third compressor, wherein the pressure sensor is positioned between an intake valve and an outlet valve of the cylinder, wherein the pressure sensor is positioned above a piston in the cylinder, and wherein the pressure sensor is configured to measure the pressure.
